(19) United States
(12) Patent Application Publication
(10) Pub. No.: US 2010/0205055 A1
(43) Pub. Date: Aug. 12, 2010

(54) Method of knowledge accumulation based on attribution for all contributions

(76) Inventor: Raghuram Saraswati, Chennai (IN)

Correspondence Address: LOUIS VENTRE, JR, 2483 OAKTON HILLS DRIVE, OAKTON, VA, 22124-1530, US

(21) Appl. No.: 12/691,000

(22) Filed: Jan. 21, 2010

Related U.S. Application Data
(60) Provisional application No. 61/206,841, filed on Feb. 6, 2009.

(51) Int. Cl. G06Q 30/00; G06F 17/30; G06Q 50/00

(52) U.S. Cl. 705/14.49; 707/741; 705/26; 707/E17.002

(57) ABSTRACT

A method is disclosed for knowledge accumulation from citizens based on attribution for all contributions. The steps include: providing an electronic database stored on a computer; configuring the computer to enable access to the electronic database; preparing an author contribution form on paper; providing the author contribution form to an author; receiving and scanning a completed author contribution form to create a digitized version with the author's real name; storing the digitized version; preparing and storing an index entry; enabling the author to supplement the digitized version; displaying the digitized version to real identified people; accepting and storing data supplementing the digitized version; and, enabling direct contact with the author. Optional steps include: identifying commercial information; enabling commercial transactions; offering and displaying advertisements; enabling storage of real time data; identifying the availability of local products and services; recording and displaying changes in such availability.

### CROSS-REFERENCE TO RELATED APPLICATION

This application claims the benefit of U.S. Provisional Application No. 61/206,841, filed 6 Feb. 2009, which is hereby incorporated by reference herein.

### TECHNICAL FIELD

In the field of social interaction, a method is disclosed for building on the knowledge and contributions of identified individuals by creating an electronic database for knowledge sharing and commercial use from paper-document submissions, by managing data stored in the electronic database, and by providing access to the data from a remote site.

### BACKGROUND ART

Since the time of formation of civilized societies, inter and intra society communication and co-operation and material exchanges and trade have been the hallmark of societal development and growth.

Newspapers and the use of the internet have furthered a one-way flow of information in the sense that the flow is from a few source points to a large number of recipients. Such flow could be characterized as percolation.

As the World Wide Web (WWW) has grown to be an integral source for information and communication, advertising has become a major source of revenue for Web site providers and has created an additional medium for advertisers to present their messages to a wide audience. Increased bandwidth has led to more sophisticated and eye catching advertising. However, even with the increased download time provided by increased bandwidth, pages with extensive and/or sophisticated advertising can be slow to load. This may result in a Web site user becoming disinterested and navigating elsewhere.

In its early years, the Web provided only static content, that is, every person accessing the same Web page would view the exact same information. Later, Web publishers began to provide custom content wherein, for example, a user could specify what types of information they wanted to see on a Web page.

In order to provide custom content, the user would most often be required to register with the Web site in order to receive logon credentials. When a returning user would logon to a Web site, the user's preferences could be retrieved from a database and the content matching those preferences could be displayed within the user's Web browser. In the latest evolutionary cycle of the Internet, publishers devised methods to provide dynamic content to users based on the user's “surfing” habits.

The growth of the Internet has brought a corresponding increase in the number and variety of ways good and services are exchanged. Today, when users wish to buy or sell goods, they may turn to a variety of online websites for aid. For example, virtual bulletin boards, such as craigslist.com, have become popular in many large cities around the nation. These bulletin boards allow users to publicly post items for sale or rent, requests for items to purchase, job opportunities, community involvement opportunities, or the like. Some sites, such as EBAY, and the like, provide environments that allow users to conduct an auction for various products. In addition, other types of websites allow for centralized event organization. These invitation websites, such as EVITE, provide web-based RSVP services for event planners. A third type of website, such as MYSPACE, FACEBOOK, FRIENDSTER, LINKEDIN, or the like, provide networking among social groups, allowing people to talk with other people or meet people through their direct friends and coworkers.

With the expansion of the Internet comes the question of how to take advantage of the growing flow of information. Virtual bulletin boards provide no way for a user to control who views or responds to posts. Centralized event organization websites are limited to invited users and static, planned event RSVPs. Social networking websites provide ample user control over social networks, but do not provide services to aid in the exchange of goods and services. Therefore, it is with respect to these considerations and others that the present invention has been made.

### SUMMARY OF INVENTION

A method of knowledge accumulation from citizens based on attribution for all contributions. The steps include: providing an electronic database stored on a computer; configuring the computer to enable access to the electronic database by an access device; enabling the access device to include a direct-connection computer, an Internet-connected computer; and, a telephone; preparing an author contribution form on physical paper; providing the author contribution form to an author; receiving a completed author contribution form from a named author; scanning the completed author contribution form to create a digitized version with the author's real name; storing the digitized version in the electronic database; preparing an index entry; storing each index entry in the electronic database; enabling the author to supplement the digitized version; displaying the digitized version to real identified people; accepting and storing data supplementing the digitized version; and, enabling direct contact with the author. Optional steps include: identifying commercial information in the completed author contribution form; enabling the identified person to engage in a commercial transaction pursuant to the commercial information; offering to display an advertisement when the electronic database is accessed using the access device; displaying the advertisement when the electronic database is accessed using the access device; enabling real time data to be stored in the electronic database; enabling tracking data to be stored in real time in the electronic database; identifying the availability of products and services identified as local to the author in the completed author contribution form; recording changes in such availability; and, displaying the changes when the electronic database is accessed using the access device.

### TECHNICAL PROBLEM

Reverse flow and cross flow, as differentiated from percolation, of knowledge and information has been absent in large measure in today's infrastructure. There has been little in the way of information and knowledge flowing from the society at large, both horizontally and vertically, amongst its members.

Studies have shown that such reverse and cross flow can be very relevant, and could potentially confer many continually beneficial outcomes for society and its members at large. These benefits include knowledge sharing and trade enhancement.

Internet blogging has attempted to address this felt need, to enable interaction amongst people. However this has severe limitations. The foremost being the generally anonymous nature of the participants. A second limitation is that communication sharing and participation is between those sharing common thought processes, in common interest spheres, and involving like-minded participation. A third limitation is the absence of the knowledge, being available or made available to the larger society, unless through a focused participation in the process. In the case of newspapers, occasionally, members of the general public/society do share their thoughts/knowledge. Such exercises are far and few between, generally lack cohesive continuity, are theme or current event specific, and are almost always not from easily identifiable sources.

### SOLUTION TO PROBLEM

The solution is an internet/intranet/network-based knowledge-base website and a physical real world interface wherein the data is collected by and from real world people and collected by registered visitors/communicators. The knowledge base depends upon the user community and accessibility by a user. A series of intelligent sorting and search algorithms is used to gain and then transfer knowledge within the society. The invention technology uses a combination of high speed computers, software algorithms to collate, segregate and use cloud computing to disseminate on real time, and also on a legacy basis. Computer hierarchy structures are built into the invention.

The solution is to implement a method that clearly identifies the source of common knowledge, through its contributors, which will be in the contributors own handwriting, through a widely circulated contribution handout/mailer, without any time bar, thus enabling reverse and cross flow of knowledge.

The solution is further a method that shares knowledge across interest groups, and serves as a permanent repository of such information/knowledge, without any time limitation. This enables continuous accretion and enrichment of vast reservoirs of knowledge.

The solution is further a method that works in tandem both in the conventional and electronic delivery modes thereby constantly increasing its outreach across regions and geographies and people.

The solution is further a method that provides other opportunities to members of common communities on a constant and continuing basis, through provision of various goods and services and advertising. The invention enables culling user preferences for targeted commerce. The invention enables trade and commerce to be conducted at horizontal societal sub-layers, in stark departure from the present form of hierarchal, vertical supplier consumer model of trade and commerce.

### ADVANTAGEOUS EFFECTS OF INVENTION

The method of the invention has an advantage in that businesses and professionals such as store owners, physicians, lawyers, dentists, mechanics, and service providers both rural and urban will have many tools and services at their disposal for creating dynamic webpage or e-commerce web pages based upon paper-form contributions. In addition educators and other individuals have at their disposal a series of options for creating web pages for their students or other target audience.

The method of the invention has an advantage in that it is specially designed to incorporate the preparation and use of pre-printed forms, as the primary mode to elicit written contributions from members of the general public on any subject of interest to the contributor, which forms a personalized and verbalized narrative of the contributor, including trade preferences and commerce related narratives. Thus, the advantage inures with an attributed information source and not projected or surrogate information, the continuing validation is self-generated and voluntary.

The method of the invention has an advantage in that the author's knowledge contribution on a form is enhanced with indexing to aid in searching, the form is electronically scanned and is thereafter available for viewing by others. Mathematical algorithms may be employed for supplemental contributions through the use of interactive telecommunications technology and computer networks.

The method of the invention has an advantage in that it enables indexing or categorization of the stored contributions by topics/subject. Indexing promotes interest group based dialogue and interaction among real people, both in the physical world and electronic virtual world. It enables de-layered, non hierarchal trade and commercial opportunities including to and fro direct and mass advertising.

The method of the invention has an advantage in that it can facilitate the transaction of commerce, preferably through the web over a secured network amongst the growing community of the contributors and within the larger community.

The method of the invention has an advantage in that it provides opportunities for inter/intra community advertising including commerce based advertising, thus enabling goods and service providers to participate, through banner ads, specific ads, need oriented information offers, after collating the preferences from the contributors.

The method of the invention has an advantage in that it provides opportunities for inter/intra community trade including barter trade and commerce, thus enabling even micro level goods and service providers to participate through inter/intra community and localized geographic domains thus enhancing their trade throughputs. This advantage derives in part from an ability to seamlessly collate the preferences of contributors, which is made possible only with the real identity and real life aspect of this invention.

The method of the invention has an advantage in that it enables an option of recording an author's contribution in a machine readable paper format, with specific data and content identification to enable the computer system to preserve intellectual property related content. Simultaneously this embodiment permits specific data mining opportunities and specific protocols to be captured and embedded in real time in a physical world and a real people environment.

### BRIEF DESCRIPTION OF DRAWINGS

The drawings show preferred embodiments of the method of the invention. Reference numbers in FIG. 1 are given 100 series numbers and new reference numbers in FIG. 2 are given the 200 series numbers.

FIG. 1 is a flow diagram of a preferred method of the invention.

FIG. 2 is a flow diagram of optional steps in embodiments of the method of the invention.

### DESCRIPTION OF EMBODIMENTS

In the following description, reference is made to the accompanying drawings, which form a part hereof and which illustrate several embodiments of the present invention. The drawings and the preferred embodiments of the invention are presented with the understanding that the present invention is susceptible of embodiments in many different forms and, therefore, other embodiments may be utilized and operational changes may be made, without departing from the scope of the present invention. For example, the steps in the method of the invention may be performed in any order when the functions they perform so admit.

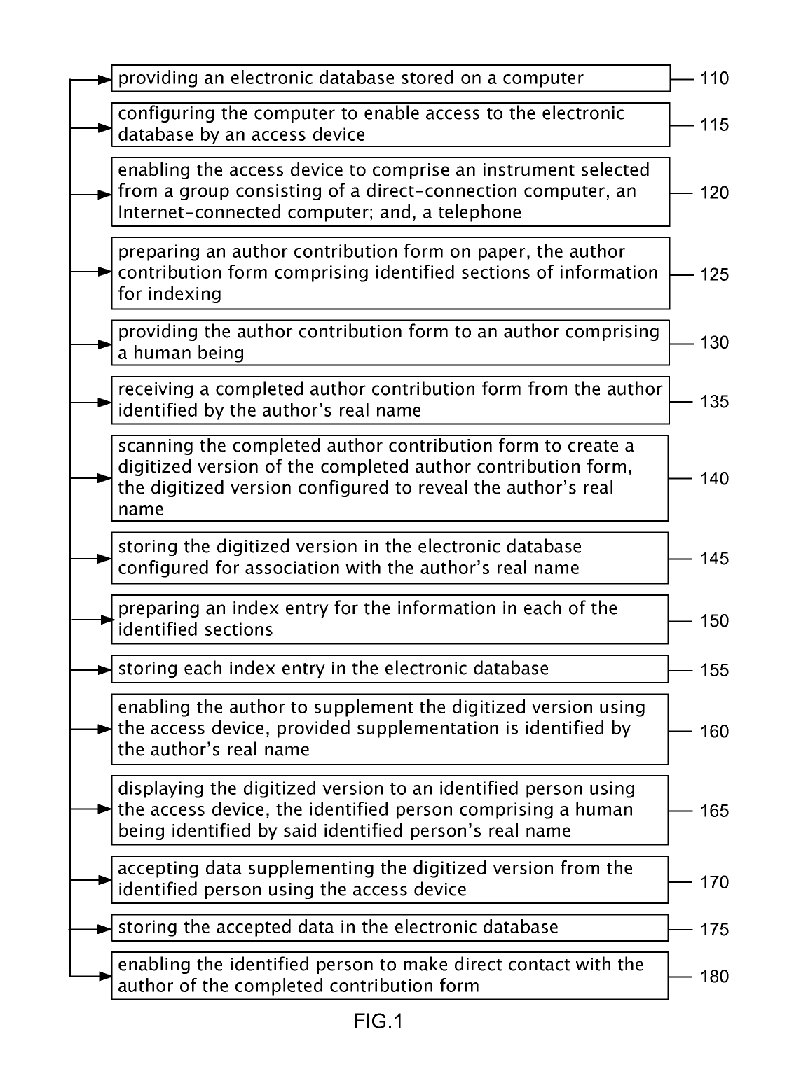

A flow diagram of a preferred method of the invention is illustrated in FIG. 1. It is a method of knowledge accumulation from citizens based on attribution for all contributions comprising a step of providing an electronic database stored on a computer (110). The electronic database is preferable a structure organized and searchable by information contributions of citizens in the form of scanned images of completed author-contribution paper forms, supplemental electronic text, video files, audio files and associated data such as real time tracking information. The computer is preferably a computer server connected to networks accessible by real people at remote locations.

The electronic database would contain and house the information/data provided by the real-life users and contributors who are not anonymous and who have voluntarily made their written contributions in the contribution handouts/mailers, that is the completed paper forms. The computer may comprise a stand-alone server or a complex of computers in a dedicated cloud computing environment.

This preferred method further comprises a step of configuring the computer to enable access to the electronic database by an access device (115). The computer must be accessible by an instrument suitable for access to the electronic database, consistent with the steps of the invention.

This preferred method further comprises a step of enabling the access device to comprise an instrument selected from a group consisting of a direct-connection computer, an Internet-connected computer, and a telephone (120). These instruments enable remote or local access to the electronic database. A cellular or mobile telephone would enable the most versatile use of the invention.

This preferred method further comprises a step of preparing an author contribution form on paper, the author contribution form comprising identified sections of information for indexing (125). The paper form is a key component of the invention, as it allows a diverse cross-section of citizenry to provide a knowledge contribution in a format widely known throughout the world. It bridges a gap between the fully electronic world and hand or type written world. The author contribution form comprises identified sections of information for indexing, which is needed to aid in organizing the data comprising the image of the paper form to be stored in the electronic database.

This preferred method further comprises a step of providing the author contribution form to an author comprising a human being (130). This step is also an important step in the invention because it enables the author to put his contribution down in a tangible form that is later to become a part of the knowledge base in the electronic database.

An exemplary embodiment of the present invention is to provide a self-generated unique identification code to all contributors (gleaned from information/data which may be in visual/audible/sensory/written forms of communication and more importantly voluntarily provided by real users and real people) through access control mechanisms and through accesses to specific web page, provided on their handout/mailer. Further a complete updated list of the unique identification marks of all the handouts/mailers available are made on the website for enabling all website visitors to browse, and view the contributions of various contributors.

From the above exemplary embodiment of the present invention flows another logical embodiment to vertically divide and clearly segregate anonymous and non anonymous engagement/interface/interaction so important to coexist and do so as distinctly separate activities. The present invention also offers the process to achieve such a distinction by clearly identifying real people in unique ways.

This preferred method further comprises a step of receiving a completed author contribution form from the author identified by the author's real name (135). It necessarily follows that once an author has provided a written contribution on the author contribution form, the next important step is receiving that paper document, either directly or indirectly, from the author or writer. An important feature of the invention is that author contributions must be associated with a real name of the author. The invention is based on knowledge accumulation with attribution to the actual person from whom that knowledge was obtained. This source data is important in both accountability and in credit for the intellectual property organized by the invention. For example, inter/intra-user engagement in real life can consolidate and index data on local availability of physical, human, and other natural resources and to search for available intellectual property copyrights, including source inputs of geographical indications.

This preferred method further comprises a step of scanning the completed author contribution form to create a digitized version of the completed author contribution form, the digitized version configured to reveal the author's real name (140). The scanning step converts a paper document, the completed author contribution form, to an electronic document, which can then be stored in the electronic database. The author's contribution can begin to be disseminated for others once it is converted to digitized form, but it is important that the digitized version preserve and reveal the author's real name so that this person is associated with his contribution to give the author credit for his or her contribution and to attribute any opinions directly to the person giving them.

The digitized version may be in any format convenient to organizing the documents and to the storage capabilities of the computer comprising the electronic database. Typical formats of the digitized version are any of the: image formats, such as jpg, tiff, gif; document formats, such as pdf and zip; or, audio formats, such as aac, way.

While text recognition is common to convert a paper form to searchable text strings, the state of the art of this technology is not at the point where hand-written completed author contribution forms could be reliably converted. Certainly, the author may choose to type his contribution on the form, and this would facilitate text recognition, but this is neither expected nor required for the invention. It is anticipated that most digitized versions will be simple images, and conversion to text is an option, but not an important option, to implementing the invention.

This preferred method further comprises a step of storing the digitized version in the electronic database configured for association with the author's real name (145). Storage is necessary to making the form subsequently available and building on the knowledge base by supplementation. Once scanned, the digitized version of the completed author contribution form is stored in the electronic database with attribution to the author.

Optionally, the method further comprises the step of providing a microchip with the author contribution form, the microchip configured for storage of electronic data (236). Any author information provided by the author in a microchip submitted with the author contribution form would also be stored in the electronic database.

This preferred method further comprises a step of preparing an index entry for the information in each of the identified sections (150). The index entry may be as little as the author's name and may be as detailed as desired to assist others in searching for related material.

This preferred method further comprises a step of storing each index entry in the electronic database (155). Once prepared, the index entry should then be made accessible through the electronic database.

This preferred method further comprises a step of enabling the author to supplement the digitized version using the access device, provided supplementation is identified by the author's real name (160). Supplementation would preferably be by submission of additional written forms, or by adding making electronic edits or submissions, such as text, audio files, video files or text files. Each supplement would be attributed by real name to the author making the submission.

This preferred method further comprises a step of displaying the digitized version to an identified person using the access device, the identified person comprising a human being identified by said identified person's real name (165). The display of the scanned completed author contribution form is important to widespread distribution of the knowledge of the author contained in the completed form. Also, the method of the invention is dependent upon the transparent identification of all participants, including the viewers of the knowledge base comprising the electronic database. The real name of the identified person is, thus, required in order to be able to display the digitized version, the index entry, files containing audio input, video input, text input, or sensory input, or any other information contained in the electronic database.

Ideally, the method would encourage website visitors to become contributing authors and identified persons, and to make contributions through the written forms or handouts/mailers, which are initially on physical paper. Such website visitors start by identifying themselves, which means that there is no anonymity. Identification enables them to participate in inter/intra subsystem level engagements.

A distinctive feature of the invention is to build a software architecture, which provides non intrusive real life identification of the user on a continual basis. This is done using the physically identifiable inputs, voluntarily provided by the user.

Thus, identified persons, or users, are able to gain access to their own written contributions to make further contributions. They also may gain access to other written contributions. This is enabled through protocol based software architecture and subsystems, which clearly identifies the users in real world, as a continuation to their earlier identification when making the written contributions. Thus the ecosystem nurtures “real people to real people” connectivity.

As a result of the “real people to real people” connectivity, “reverse” flow of information, data, inputs commences from individuals to people clusters (society), of vital societal importance.

The method includes the option of registering an identified person, or visitor, for security and recording the visitor's physical address, to which a contribution handout/mailer may be sent to elicit a written contribution. This promotes gathering supplemental written contributions as real, physical contributions on paper. Such contributions may subsequently be digitized and added to the electronic database to create a repository building a bridge between both the physical and electronic worlds, as well as promoting commercial/non commercial advertising.

Users may continuously identify, upgrade, update, vary, verify, validate, authenticate their pages using their user devices such as desktops computers, mobile telephones, and GPS devices through public or private telecommunication networks.

This preferred method further comprises a step of accepting data supplementing the digitized version from the identified person using the access device (170). Thus, any person identified by his real name may supplement the digitized version with any submission, such as a question for the author, a text file of additional data, a paper document, an audio file, a digitized version of sensory input file, a video file, or anything else that identified person desires to add to the digitized version. Knowledge of the name of the identified person encourages responsible actions and enables the appropriate follow-up if inappropriate additions are made.

This preferred method further comprises a step of storing the accepted data in the electronic database (175). The additions or supplemental data added by the identified person and accepted become a part of the electronic database, which accumulates further knowledge based on these supplements.

This preferred method further comprises a step of enabling the identified person to make direct contact with the author of the completed contribution form (180). Direct contact with the author enables commerce or further knowledge accumulation. Enabling such direct contact may be publishing the author's address for written correspondence, by publishing the author's email address or telephone number, or by any other method of establishing contact.

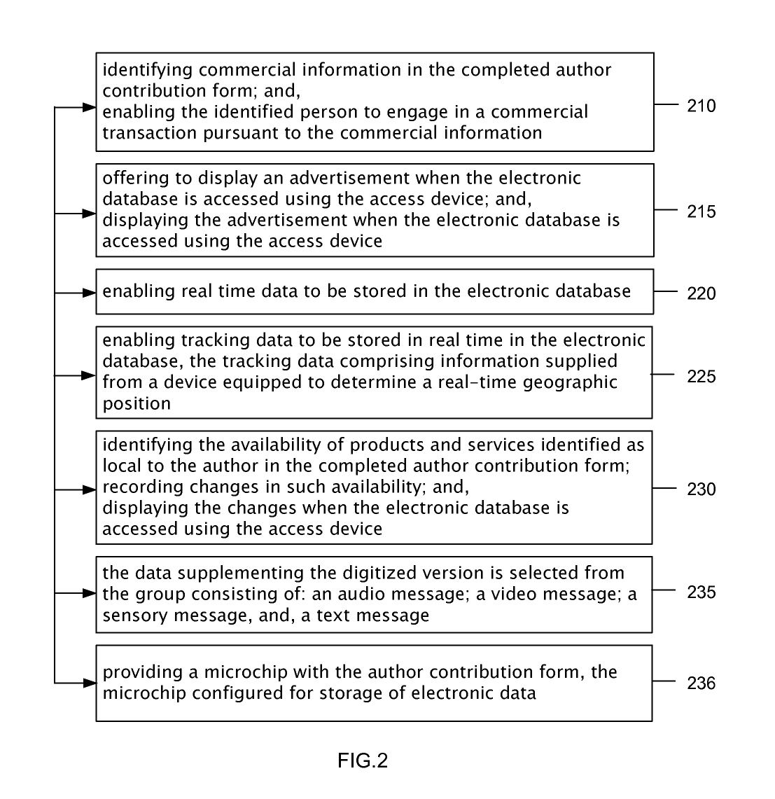

FIG. 2 is a flow diagram of optionally steps in embodiments of the invention. Optionally, the preferred method further comprises the steps of identifying commercial information in the completed author contribution form; and, enabling the identified person to engage in a commercial transaction pursuant to the commercial information (210). Commercial information is not required, but is optional. Inclusion of such information fosters commerce in goods and services local to the author. Enabling commerce may be as little as providing contact information to establish trade or barter in a particular good or service, or as much as providing a secure purchase transaction web page to accept an offer of sale and the purchase money payment.

Optionally, the preferred method further comprises steps of offering to display an advertisement when the electronic database is accessed using the access device; and, displaying the advertisement when the electronic database is accessed using the access device (215). These steps might involve advertisers having some interest in the author's contribution, but having no direct contact with the author. These steps permit the method implementer to sell advertising space to help support operation and maintenance of the electronic database.

Optionally, the preferred method further comprises the step of enabling real time data to be stored in the electronic database (220). For example, this may include web cams of a tourist attraction or production facility. Other examples are real time tracking data for package delivery, music played in a live concert, and other feeds of live events as they are happening. Thus, embodiments of the invention admit of applications where information and real life, real time data may be transferred to and from other private/public cloud computing/resident computing environments, with periodic and business protocol controlled access between any two distinct computing environments.

Optionally, the preferred method further comprises the step of enabling tracking data to be stored in real time in the electronic database, the tracking data comprising information supplied from a device equipped to determine a real-time geographic position (225). This is intended to be a useful commercial tool to monitor product delivery. However, it may also be useful for tracking other persons or objects, such as personal vehicle use by, for example, children of the vehicle owner, scientists collecting field data, or people on vacation in a remote location.

Optionally, the preferred method further comprises steps of identifying the availability of products and services identified as local to the author in the completed author contribution form; recording changes in such availability; and, displaying the changes when the electronic database is accessed using the access device (230). These steps specifically enable barter and trade of locally available products and services to be facilitated using the electronic database.

Optionally, the preferred method specifically includes the configuration wherein the data supplementing the digitized version is selected from the group consisting of: an audio message; a video message; a sensory message, and, a text message (235). Ideally, any website used to enable access to the electronic database would have the connection with the physical world—continuous identification, and verifiable real time acquisition and dissemination from real-life user-generated current news, current information, text, video, audio data. A website visitor might also be a part of the computer in real time with real life identification, by registering a specific protocol within the computer system, even before making a written contribution.

### Example

The following paragraphs describe a preferred exemplary embodiment of the method of the invention.

In this exemplary embodiment, a pre-printed multi-page paper handout/mailer, is created as the author contribution form. It is a physical, paper-printed mode to seek/invite/elicit/encourage written contribution of information from members of the general public on any subject/theme/knowledge/sharing/creative abilities/events/issues-specific or otherwise/local inputs/local problems/on anything/subject of contemporary/historical nature or value and on anything of interest to the contributor.

In this exemplary embodiment, once completed, the author contribution form becomes a personalized and verbalized narrative of the contributor. Such contributions are made on the specially designed author contribution form, which is a handout/mailer printed on paper. The handout/mailer has provision for the contributor to write in his own handwriting, in a language of his choice, with provision for personalizing it as his or her own handout and written contribution.

In this exemplary embodiment, the personalization is done by adding a photograph/picture/image with the encouraged objective of identifying the contributor with his hand written contribution on one of the pages. The author contribution form enables this personalization to be both a real time identification and unique communication conduit.

On the first page of the handout/mailer, there is a space for a unique number based identification mark, to clearly identify the contribution with the contributor and his location.

On the second page of the handout/mailer the contributor writes and makes his written contribution in the space provided, and fills in the date, and affixes his signature along with his name.

On the third page of the handout/mailer the contributor, writes about his vision and any other input he would like to provide, concerning himself, his immediate society or the larger society, and add local, traditional, other knowledge generally now unknown in the common domain. The space is designed and provided for the sake of aforesaid contribution.

On the fourth page of the handout/mailer space is provided for the contributor to attach a personal effect. Examples of such personal effect are: an analogue or digitized photograph/image/picture of anything with which he personally likes to be identified, thus being a real identification; an analogue or digitized text file, audio file, or video file; and, an analogue or digitized sensory message or input such as a personal fragrance, vibratory rhythm, personal voice message, personal video message, and visual alert. The mailer may include an electronic microchip for recording or storing data or information from the contributor, or it may simply include space for the contributor to attach an electronic microchip.

In this exemplary embodiment, the completed author contribution form, that is the filled in handout/mailer, is received by the method implementer and reviewed for appropriateness of its content. It is then electronically scanned to create a digitized version. It is then stored in the electronic database and posted/hosted on a specific website for this purpose. This becomes the specific web page of the contributor. The completed author contribution form, that is the paper handout/mailer, is then archived.

In this exemplary embodiment, the personally identifiable image/effect also personalizes the webpage. Such web page also serves as the contributor's personal web page on the website. The website thus becomes an aggregate of a vast collection of personal web pages of contributors in addition to other developing features.

In this exemplary embodiment, such posted/hosted contribution web pages form the starting page of every contributor's webpage, into which he can make further contributions, on a continuous basis. The contributor accesses his web page through the unique identification mark provided on his handout/mailer. A complete list of the unique identification marks of all the handouts/mailers is available on the website. This enables all website visitors to browse, and view the contributions of various contributors. This initiates a snow ball effect expanding the community of contributors.

In this exemplary embodiment, the website also has topics/subject base segmentation on the contributions hosted. This initiates interest group based dialogue, interaction amongst the community members, both in the physical world and electronic world domains, but amongst real people. Any one engaging in this will benefit at the individual, community and eventually at the societal level.

In this exemplary embodiment, there is also provided an internal search facility, which would enable the database to be accessed by any website visitor, to gain from the knowledge contained therein. Therefore any visitor to the website is also encouraged to become a contributor through a software provisioning. This is done by providing radio buttons on the home page of the website to take the website visitor to the appropriate link page on the website.

Further, on the link pages, the visitor is asked to provide his physical address, to which a contribution handout/mailer is sent, eliciting his contributions. Thus, every contribution commences in the physical world and enters the repository in the physical and electronic world.

In this exemplary embodiment, each contribution page on the handout/mailer as well as on the website has space for commercial/non commercial advertising. This exemplary embodiment provides a simultaneous internet based and conventional advertising medium. This exemplary embodiment has on the web pages a built-in dynamic message bulletin board, to provide current, topical and other time based information to each contributor, which can be accessed over the internet, thus keeping the contributor in constant engagement with his chosen interaction community with inbuilt machine readability features.

In this exemplary embodiment, each page of the contributor's webpage has a provision to engage and perform real-time commerce through electronic and physical means. Commerce can be transacted amongst the growing community of the contributors and with the larger community. This is enabled by the real time database elements provided by the contributor himself, thus dispelling doubts of anonymity. This is conducted by and through the website and the physical locations provided by the contributors.

In this exemplary embodiment, cloud computing, GPS and telecommunication software along with machine readable features and physical validation features embedded in the website for this purpose. Contributors who in real time are engaged amongst themselves and others are encouraged through, to making further contributions and involve in community education, service, commerce, and sharing local, traditional knowledge, make known their talents, abilities and other things thus raising the experiential levels of individuals and also advertise. Physical world contact, communication, interaction and engagement amongst the community members is also configured in this exemplary embodiment to enable an alternate mode of delivery system for knowledge, trade and commerce of goods and services across geographical domains through GPS and mobile telecom.

This exemplary embodiment enables real-life users to use their physical mobility with GPS and advanced telecom technology to form and engage in peer to peer interaction.

This exemplary embodiment provides opportunities for inter/intra community advertising including commerce/non-commerce based advertising, thus enabling goods and service providers to participate, through banner ads, specific ads, need oriented information offers directed at real people, after computer based data mining and collation of the preferences from real data of the contributors and other community members.

This exemplary embodiment employs a computer system that is gradually expanded using the user inputs into specific subsystems called layers and modules, containing both current and legacy information and data and knowledge. The knowledge/information/data base of the computer system expands while remaining rooted to the real users.

This exemplary embodiment's website becomes a people's website, with different modules, layers and sub layers for different engagements such as civic issues, public-private partnerships, and peer focused databases, commerce based and self advertising, resource identification and tracking, conduct of targeted commerce in goods and services, and barter relationships amongst individuals with real identification and other segments.

This exemplary embodiment enables governments and people at large and across geographies to have an interactive repository of real time and real world data, information and knowledge. Such repository is generated and maintained by real user(s), across geographies, identified, validated, authenticated current information/data source points, data segregation/consolidation, actionable inputs, written news items including photographs, video, text messages in a computing cloud, which is constantly verifiable and updateable.

The above-described embodiments including the drawings are examples of the invention and merely provide illustrations of the invention. Other embodiments will be obvious to those skilled in the art. Thus, the scope of the invention is determined by the appended claims and their legal equivalents rather than by the examples given.

### INDUSTRIAL APPLICABILITY

The invention has application to the knowledge, commercial products and commercial services industries.

What is claimed is:

1. A method of knowledge accumulation from citizens based on attribution for all contributions comprising the steps of:
providing an electronic database stored on a computer;
configuring the computer to enable access to the electronic database by an access device;
enabling the access device to comprise an instrument selected from a group consisting of: a direct-connection computer; an Internet-connected computer; and, a telephone;
preparing an author contribution form on paper, the author contribution form comprising identified sections of information for indexing;
providing the author contribution form to an author comprising a human being;
receiving a completed author contribution form from the author identified by the author's real name;
scanning the completed author contribution form to create a digitized version of the completed author contribution form, the digitized version configured to reveal the author's real name;
storing the digitized version in the electronic database configured for association with the author's real name;
preparing an index entry for the information in each of the identified sections;
storing each index entry in the electronic database;
enabling the author to supplement the digitized version using the access device, provided supplementation is identified by the author's real name;
displaying the digitized version to an identified person using the access device, the identified person comprising a human being identified by said identified person's real name;
accepting data supplementing the digitized version from the identified person using the access device;
storing the accepted data in the electronic database; and,
enabling the identified person to make direct contact with the author of the completed contribution form.

2. The method of claim 1, further comprising the steps of:
identifying commercial information in the completed author contribution form; and,
enabling the identified person to engage in a commercial transaction pursuant to the commercial information.

3. The method of claim 1, further comprising the steps of:
offering to display an advertisement when the electronic database is accessed using the access device; and,
displaying the advertisement when the electronic database is accessed using the access device.

4. The method of claim 1, further comprising the step of enabling real time data to be stored in the electronic database.

5. The method of claim 1, further comprising the step of enabling tracking data to be stored in real time in the electronic database, the tracking data comprising information supplied from a device equipped to determine a real-time geographic position.

6. The method of claim 1, further comprising the steps of:
identifying the availability of products and services identified as local to the author in the completed author contribution form;
recording changes in such availability; and,
displaying the changes when the electronic database is accessed using the access device.

7. The method of claim 1 wherein the data supplementing the digitized version is selected from the group consisting of: an audio message; a video message; a sensory message, and, a text message.

8. The method of claim 1, further comprising the step of providing a microchip with the author contribution form, the microchip configured for storage of electronic data.
